(19) United States
(12) Patent Application Publication
(10) Pub. No.: US 2020/0075000 A1
(43) Pub. Date: Mar. 5, 2020

(54) SYSTEM AND METHOD FOR BROADCASTING FROM A GROUP OF SPEAKERS TO A GROUP OF LISTENERS

(71) Applicant: Halloo Incorporated, Bellevue, WA (US)

(72) Inventor: Michael Saad Merhej, Bellevue, WA (US)

(73) Assignee: Halloo Incorporated, Bellvue, WA (US)

(21) Appl. No.: 16/119,870

(22) Filed: Aug. 31, 2018

(51) Int. Cl. G10L 15/22; G06F 17/28; H04R 3/12; G10L 15/26; G10L 13/04; G10L 15/30

(52) U.S. Cl. CPC G10L 15/22; G06F 17/289; G10L 15/30; G10L 15/265; G10L 13/043; H04R 3/12

(57) ABSTRACT

A processor implemented method for broadcasting from a group of speakers having speaker devices to a group of listeners having listener devices is provided. The method includes: obtaining voice inputs associated with a common topic from the speaker devices associated with the group of speakers; automatically transcribing the voice inputs to obtain text segments; obtaining at least one of a speaker rating score for at least one speaker in the group of speakers and a relevance rating score with respect to the group of listeners and a common topic for at least one of the text segments or the voice inputs; selecting at least a subset of the text segments to produce a selected subset of text segments; converting the selected subset of text segments into a selected subset of voice outputs and serially broadcasting the selected subset of voice outputs to the listener devices of the group of listeners.

### BACKGROUND

### Technical Field

Embodiments of this disclosure generally relate to voice communication among a group of users, and more particularly, to a system and method for broadcasting from a group of speakers having speaker devices to a group of listeners having listener devices.

### Description of the Related Art

No one system or method has been proven to be ideal for broadcasting under any and all circumstances. Group text messaging or chat has been commonly used for a group of users to communicate with each other with reference to a common topic. However, communication that uses voice often has a better impact than plain text because human beings often feel more engaged in conversation, and retain information better by listening to audio that includes a voice than by reading text. Group communication using voice has several applications including those for education, teamwork, social interaction, sports and business. One approach to enable a group of users to communicate using voice is a conference call through a telephone, or VoIP (Voice over Internet Protocol). Television or radio channels may also be used to broadcast audio content that includes voice. However, when compared to text messaging, voice communication in a group is more challenging to implement effectively.

One challenge faced while enabling voice communication with a group of participants is that multiple participants may end up speaking at the same time, creating voice overlap, which makes it difficult for listeners to process audio information. Another challenge is background noise. If even one participant is at a location where there is background noise, it affects the quality of the sound for the entire group. Yet another challenge, particularly in a larger group, lies in ensuring that the voice content is of interest, or relevant, for the participants in the group. Still another challenge arises when the different participants are in different locations or time zones, or use different communication channels such as cable, radio, the internet, etc., to communicate with each other, because in those situations typically there is a delay between the transmission of the voice content by one participant, and receipt of the voice content by another participant, and those delays may vary noticeably among the participants.

One approach to managing group communication using voice involves muting one or more participants while one participant is speaking. The muting may either be done voluntarily by a participant (e.g. a participant who is at a location where there is background noise), or by a human moderator, who determines who should be allowed to speak and at what time. Various other systems exist that may individually either transcribe, translate or filter content, but none of these systems address the multiple challenges in group voice communication such as voice overlap, background noise, delay, relevance etc.

### SUMMARY

In view of the foregoing, an embodiment herein provides a processor implemented method for broadcasting from a group of speakers having speaker devices to a group of listeners having listener devices. The method includes the steps of (i) obtaining voice inputs associated with a common topic from the speaker devices associated with the group of speakers, (ii) automatically transcribing the voice inputs to obtain text segments, (iii) obtaining at least one of (a) a speaker rating score for at least one speaker in the group of speakers and (b) a relevance rating score with respect to at least one of the group of listeners or a common topic for at least one of the text segments or the voice inputs, (iv) selecting at least a subset of the text segments to produce a selected subset of text segments based on at least one voice input selection criteria selected from (a) the speaker rating score and (b) the relevance rating score to obtain a selected subset of text segments, (v) converting the selected subset of text segments into a selected subset of voice outputs, and (vi) serially broadcasting the selected subset of voice outputs to the listener devices of the group of listeners. A voice output of a selected speaker, from the selected subset of voice outputs, is different from a voice input of the selected speaker, from the voice inputs

In some embodiments, the method further includes dynamically selecting the group of listeners based on group selection criteria selected from at least one of (i) a quantity of voice inputs or (ii) speaker rating scores given by each of the group of listeners to speakers associated with a selected subset of text segments to split the group of listeners into a first group of listeners and a second group of listeners. A first selected subset of voice outputs may be serially broadcasted to a first group of listener devices associated with the first group of listeners. A second selected subset of voice outputs may be serially broadcasted to a second group of listener devices associated with the second group of listeners.

In some embodiments, the at least one speaker is a member of the first group of listeners and the second group of listeners.

In some embodiments, the first selected subset of voice outputs is determined based on (i) a speaker rating score, and (ii) a relevance rating score of a first set of speakers with respect to at least one of the first group of listeners or a common topic. The second selected subset of voice outputs may be determined based on (i) a speaker rating score, and (ii) a relevance rating score of a second set of speakers with respect to at least one of the second group of listeners or a common topic.

In some embodiments, the method further includes translating the text segments from a first language to a second language. The second language is different than the first language and the second language is specified in a language preference of the group of listeners. At least one of the voice inputs may be received in the first language and at least one of the selected subset of voice outputs may be generated in the second language.

In some embodiments, the method further includes (i) obtaining an input time stamp associated with at least one of the voice inputs to determine a latency characteristic by comparing the input time stamp against a reference time clock and (ii) associating the input time stamp associated with the at least one of the voice inputs with a specific point identified by the reference time clock in the broadcast stream of the live event. The common topic may be a broadcast stream of a live event. A timing of broadcast of a voice output that is generated based on the at least one of the voice inputs may be synchronized with the specific point in the broadcast stream of the live event by individually compensating for the latency in receiving the broadcast stream by the group of listeners. Voice inputs from speakers having a lower latency may be delayed to synchronize with voice inputs from speakers having a higher latency.

In some embodiments, the method further includes (i) analyzing the broadcast stream to determine a variance score of an audio or video of the broadcast stream within a time period t, (ii) determining an event indication score and an event type associated with the specific point in the broadcast stream of the live event based on the variance score, and at least one of the audio or the video, (iii) selecting a sound effect that is associated with the event type from a database of sound effect templates and (iv) appending the sound effect to the voice output that is associated with the specific point in the broadcast stream of the live event.

In some embodiments, the method further includes dynamically adjusting a speed of speech of one or more of the selected subset of voice outputs to enable broadcasting more of the selected subset of voice outputs within a given period of time.

In some embodiments, the method further includes the step of determining one or more latency characteristics selected from (a) a type of broadcast medium, (b) a location, or (c) a time zone of a live event for the group of listeners.

In some embodiments, the method further includes the step of dynamically selecting the group of listeners based on the one or more latency characteristics that are common to the group of listeners.

In another aspect, a system for broadcasting from a group of speakers having speaker devices to a group of listeners having listener devices is provided. The system includes a memory that stores a set of instructions and a processor that executes the set of instructions and is configured to (i) obtain voice inputs associated with a common topic from the speaker devices associated with the group of speakers, (ii) automatically transcribe the voice inputs to obtain text segments, (iii) obtain at least one of (a) a speaker rating score for at least one speaker in the group of speakers and (b) a relevance rating score with respect to at least one of the group of listeners or a common topic for at least one of the text segments or the voice inputs, (iv) select at least a subset of the text segments to produce a selected subset of text segments based on at least one voice input selection criteria selected from (a) the speaker rating score and (b) the relevance rating score to obtain a selected subset of text segments, (v) convert the selected subset of text segments into a selected subset of voice outputs and (vi) serially broadcast the selected subset of voice outputs to the listener devices of the group of listeners. In some embodiments, the voice inputs may be obtained from the speaker devices. A voice output of a selected speaker, from the selected subset of voice outputs, is different from a voice input of the selected speaker, from the voice inputs.

In some embodiments, the processor is further configured to dynamically select the group of listeners based on group selection criteria selected from at least one of (i) a quantity of voice inputs or (ii) speaker rating scores given by each of the group of listeners to speakers associated with a selected subset of text segments to split the group of listeners into a first group of listeners and a second group of listeners. A first selected subset of voice outputs may be serially broadcasted to a first group of listener devices associated with the first group of listeners and a second selected subset of voice outputs may be serially broadcasted to a second group of listener devices associated with the second group of listeners.

In some embodiments, the first selected subset of voice outputs is determined based on (i) a speaker rating score, and (ii) a relevance rating score of a first set of speakers with respect to at least one of the first group of listeners or a common topic. The second selected subset of voice outputs may be determined based on (i) a speaker rating score, and (ii) a relevance rating score of a second set of speakers with respect to at least one of the second group of listeners or a common topic.

In some embodiments, the text segments are translated from a first language to a second language. The second language is different than the first language and the second language is specified in a language preference of the group of listeners. At least one of the voice inputs are received in the first language and at least one of the selected subset of voice outputs are generated in the second language.

In some embodiments, the processor is further configured to (i) obtain an input time stamp associated with at least one of the voice inputs to determine a latency characteristic by comparing the input time stamp against a reference time clock and (ii) associate the input time stamp associated with the at least one of the voice inputs with a specific point identified by the reference time clock in the broadcast stream of the live event. The common topic may be a broadcast stream of a live event. A timing of broadcast of a voice output that is generated based on the at least one of the voice inputs may be synchronized with the specific point in the broadcast stream of the live event by individually compensating for the latency in receiving the broadcast stream by the group of listeners. Voice inputs from speakers having a lower latency may be delayed to synchronize with voice inputs from speakers having a higher latency.

In some embodiments, the processor is further configured to (i) analyze the broadcast stream to determine a variance score of an audio or video of the broadcast stream within a time period, (ii) determine an event indication score and an event type associated with the specific point in the broadcast stream of the live event based on the variance score, and at least one of the audio or the video, (iii) select a sound effect that is associated with the event type from a database of sound effect templates and (iv) append the sound effect to the voice output that is associated with the specific point in the broadcast stream of the live event.

In some embodiments, the processor is further configured to dynamically adjust a speed of speech of one or more of the selected subset of voice outputs to enable broadcasting more of the selected subset of voice outputs within a given period of time.

In some embodiments, the processor is further configured to determine one or more latency characteristics selected from (a) a type of broadcast medium, (b) a location, or (c) a time zone of a live event for the group of listeners.

In some embodiments, the processor is further configured to dynamically select the selected group of listeners based on the one or more latency characteristics that are common to the group of listeners.

In another aspect, one or more non-transitory computer readable storage mediums storing one or more sequences of instructions, which when executed by one or more processors, causes a processor implemented method for broadcasting from a group of speakers having speaker devices to a group of listeners having listener devices is provided. The method includes the steps of: (i) obtaining voice inputs associated with a common topic from the speaker devices associated with the group of speakers; (ii) automatically transcribing the voice inputs to obtain text segments; (iii) obtaining at least one of (a) a speaker rating score for at least one speaker in the group of speakers and (b) a relevance rating score with respect to at least one of the group of listeners or a common topic for at least one of the text segments or the voice inputs; (iv) selecting at least a subset of the text segments to produce a selected subset of text segments based on at least one voice input selection criteria selected from (a) the speaker rating score and (b) the relevance rating score to obtain a selected subset of text segments; (v) converting the selected subset of text segments into a selected subset of voice outputs and (vi) serially broadcasting the selected subset of voice outputs to the listener devices of the group of listeners. A voice output of a selected speaker, from the selected subset of voice outputs, is different from a voice input of the selected speaker, from the voice inputs.

In some embodiments, the one or more non-transitory computer readable storage mediums storing one or more sequences of instructions, which when executed by one or more processors further causes dynamically selecting the group of listeners based on group selection criteria selected from at least one of (i) a quantity of voice inputs or (ii) speaker rating scores given by each of the group of listeners to speakers associated with a selected subset of text segments to split the group of listeners into a first group of listeners and a second group of listeners. A first selected subset of voice outputs may be serially broadcasted to a first group of listener devices associated with the first group of listeners. A second selected subset of voice outputs may be serially broadcasted to a second group of listener devices associated with the second group of listeners.

In some embodiments, the first selected subset of voice outputs may be determined based on (i) a speaker rating score, and (ii) a relevance rating score of a first set of speakers with respect to at least one of the first group of listeners or a common topic. The second selected subset of voice outputs may be determined based on (i) a speaker rating score, and (ii) a relevance rating score of a second set of speakers with respect to at least one of the second group of listeners or a common topic.

In some embodiments, the one or more non-transitory computer readable storage mediums storing one or more sequences of instructions, which when executed by one or more processors further causes translating the text segments from a first language to a second language, wherein the second language is different than the first language and the second language is specified in a language preference of the group of listeners. At least one of the voice inputs may be received in the first language and at least one of the selected subset of voice outputs may be generated in the second language.

In some embodiments, the one or more non-transitory computer readable storage mediums storing one or more sequences of instructions, which when executed by one or more processors further causes (i) obtaining an input time stamp associated with at least one of the voice inputs to determine a latency characteristic by comparing the input time stamp against a reference time clock and (ii) associating the input time stamp associated with the at least one of the voice inputs with a specific point identified by the reference time clock in the broadcast stream of the live event. The common topic may be a broadcast stream of a live event. A timing of broadcast of a voice output that is generated based on the at least one of the voice inputs may be synchronized with the specific point in the broadcast stream of the live event by individually compensating for the latency in receiving the broadcast stream by the group of listeners. Voice inputs from speakers having a lower latency may be delayed to synchronize with voice inputs from speakers having a higher latency

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates broadcasting from a group of speakers having speaker devices to a group of listeners having listener devices through a network and a communicatively coupled server according to some embodiments herein;

FIG. 2 illustrates a block diagram of the server of FIG. 1 according to some embodiments herein;

FIG. 3 is a flow diagram that illustrates a method of broadcasting from a group of speakers having speaker devices to a group of listeners having listener devices according to some embodiments herein;

FIG. 4 is a block diagram of a speaker device and a listener device according to some embodiments herein; and

FIG. 5 is a block diagram of the server of FIG. 1 used in accordance with some embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

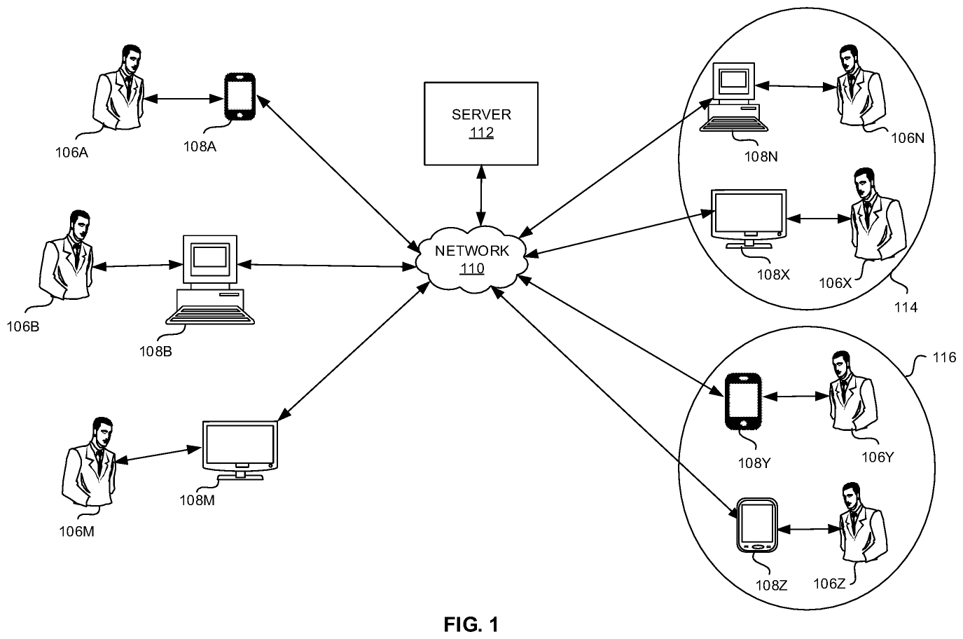

There remains a need for a system and method for broadcasting from a group of speakers having speaker devices to a group of listeners having listener devices. Referring now to the drawings, and more particularly to FIGS. 1 through 5, where similar reference characters denote corresponding features consistently throughout the figures, there are shown preferred embodiments.

FIG. 1 is a block diagram that illustrates broadcasting from a group of speakers 106A-M having speaker devices 108A-M, such as a smart phone 108A, a personal computer (PC) 108B and a networked monitor 108C, to a group of listeners 106N-Z having listener devices 108N-Z such as a personal computer (PC) 108N, a networked monitor 108X, a tablet 108Y, and a smart phone 108Z through a communicatively coupled server 112 and a network 110 according to some embodiments herein. The group of speakers 106A-M may use the speaker devices 108A-M to communicate voice inputs associated with a common topic to the server 112. In some embodiments, at least some speaker devices 108A-M are also listener devices 108N-Z. In some embodiments, all the speaker devices 108A-M are also listener devices 108N-Z. In some embodiments, the server 112 obtains the voice inputs from speaker voices in the group of speakers 106A-M having a designated common topic. For example, the common topic may be a project, a course content, a hobby, etc. In some embodiments, the common topic is directed to a live event that is broadcast through media such as the Internet, television, radio etc. The speaker devices 108A-M, without limitation, may be selected from a mobile phone, a Personal Digital Assistant, a tablet, a desktop computer, a laptop, or any device having a microphone and connectivity to a network. The listener devices 108N-Z, without limitation, may be selected from a mobile phone, a Personal Digital Assistant, a tablet, a desktop computer, a laptop, a television, a music player, a speaker system, or any device having an audio output and connectivity to a network. In some embodiments, the network 110 is a wired network. In some embodiments, the network 110 is a wireless network. The voice inputs may be automatically transcribed at the speaker devices 108A-M or at the server 112 to obtain corresponding text segments. In some embodiments, the transcribing includes voice recognition of the voice inputs. The voice recognition may be based on one or more acoustic modeling, language modeling or Hidden Markov models (HMMs).

The server 112 obtains at least one of (i) a speaker rating score for at least one speaker in the group of speakers 106A-M and (ii) a relevance rating score with respect to the group of listeners 106N-Z and/or a common topic for at least one of the text segments or the voice inputs. The relevance rating score may be different for different groups of listeners since different listeners may relate to the voice inputs to a different extent. The relevance rating score may also be different for different common topics. The relevance rating score may be updated dynamically while the listeners are listening to the broadcasted voice outputs. In some embodiments, the speaker rating score associated with the group of speakers 106A-M includes at least a speaker rating value. In some embodiments, the speaker rating value, without limitation, may include at least one of (i) ranks, (ii) comments, (iii) votes, (iv) likes, (v) shares, (vi) feedback, etc. These may be weighted, averaged etc. to obtain a cumulative speaker rating value obtained for a speaker over a period of time. In some embodiments, the speaker rating score may be obtained from the group of listener devices 108N-Z of the group of listeners 106N-Z. The server 112 may select at least a subset of the text segments to produce a selected subset of text segments based on at least one voice input selection criteria selected from (i) the speaker rating score and (ii) the relevance rating score to obtain a selected subset of text segments.

The group of listeners 106N-Z may be dynamically selected based on group selection criteria selected from at least one of (i) a quantity of the voice inputs, and (ii) speaker rating scores given by each of the group of listeners 106N-Z to speakers associated with a selected subset of text segments to split the group of listeners 106N-Z into a first group of listeners 114 (e.g. a listener 106N and a listener 106X) and a second group of listeners 116 (e.g. a listener 106Y and a listener 106Z). In some embodiments, the quantity of voice inputs and the number of speakers in a group may be related by a predetermined ratio, e.g., 1:10. In some embodiments, the quantity of voice inputs may be fixed to an upper limit (e.g. up to 10 speakers, to minimize overlap and keep the voice inputs relevant). In some embodiments, a first selected subset of voice outputs is determined based on (i) a speaker rating score, and (ii) a relevance rating score of a first set of speakers with respect to at least one of the first group of listeners 114 (e.g. the listener 106N and the listener 106X) or a common topic. The first selected subset of voice outputs may be serially broadcasted to a first group of listener devices (e.g. a listener device 108N and a listener device 108X) associated with the first group of listeners 114 (e.g. the listener 106N and the listener 106X).

In some embodiments, a second selected subset of voice outputs is determined based on (i) a speaker rating score, and (ii) a relevance rating score of a second set of speakers with respect to at least one of a common topic or the second group of listeners 116 (e.g. the listener 106Y and the listener 106Z). The listeners may be dynamically split into the first group of listeners 114 and the second group of listeners 116 based on the speaker rating scores of the speakers and the relevance rating scores of the speakers for different listeners. For example, the common topic may be one with opposing sets of views with reference to different sets of opinions, political views, opposing sides playing sports such as soccer, tennis etc., fans of one band versus fans of another band, etc. Depending on the preferences of the listeners, relevance rating scores, and their tolerance levels to different views, they may be split into groups. In some embodiments, the second selected subset of voice outputs is serially broadcasted to a second group of listener devices (e.g. a listener device 108Y and a listener device 108Z) associated with the second group of listeners 116 (e.g. the listener 106Y and the listener 106Z). In some embodiments, voice inputs provided by speakers who are rated higher by certain listeners are selected for broadcasting to the group of listeners 106N-Z who have provided high ratings.

The server 112 converts the selected subset of text segments into a selected subset of voice outputs. In some embodiments, a voice output of a selected speaker, from the selected subset of voice outputs, is different from a voice input of the selected speaker, from the voice inputs. In some embodiments, the voice of the voice input may be the actual or enhanced voice of a speaker, whereas the voice of the voice output may be a computer-generated voice. Alternatively, in some embodiments, the voice of the voice input may be the actual or enhanced voice of a speaker, whereas the voice of the voice output may be a reproduction of the actual or enhanced voice of the speaker or another person.

The selected subset of voice outputs may be obtained using one or more pre-selected voice templates (e.g. avatar voices). Hence, the selected subset of voice outputs has less background noise compared to the voice inputs. In some embodiments, the background noise is eliminated altogether since only the text segments are extracted from the audio having the original voice inputs without the background noise, and the same text segments are converted to voice outputs using a text to speech conversion technique described herein. In some embodiments, the server 112 translates the text segments from a first language to a second language that is different than the first language. In some embodiments, the second language is specified as a language preference of the group of listeners 106N-Z. In some embodiments, at least one of the voice inputs are received in the first language and at least one of the selected subset of voice outputs are generated in the second language.

The server 112 serially broadcasts the selected subset of voice outputs to the listener devices 108N-Z of the group of listeners 106N-Z. In some embodiments, the server 112 may automatically (e.g. without intervention from a human operator) serialize the selected subset of voice outputs to eliminate overlap. In some embodiments, the serial order may be determined based on the relevance rating score of the voice inputs to one or more points in the broadcast stream of a live event. In some embodiments, the common topic is a broadcast stream of a particular live event. Note that the broadcast is not limited to live events and could be any type of broadcast, including without limitation, TV shows. The broadcast is not limited an any particular media either, and may be via internet streaming, satellite feed, cable broadcast, over the air broadcast, etc. The latency characteristic may be due to differences in a location of the listener, a broadcast medium through which the listener is viewing content (e.g. a live event), a time zone, a type of listener device, an Internet speed etc.

In some embodiments, timings associated with individual voice inputs from speakers 106A-M reacting to a common event, such as a goal in a sporting competition, are compared against each other to determine their individual relative delays in performance of the broadcast stream. For example, a goal being scored in a sporting event will often prompt a near immediate reaction at various delayed times (latencies) indicative of the delays in broadcast stream playback for each speaker 106A-M. Each speaker's 106A-M verbal input is converted to and compared against the verbal input of other speakers 106A-M to obtain a relative time delay for each of the speakers 106A-M. As the relative time delays are determined, the performance of the verbal output is adjusted (synchronized) so that it is in better sync with that speaker's 106A-M broadcast stream. That way if a speaker 106A-M has a substantial latency in the performance of the broadcast stream, comments from one or more other speakers 106A-M with less delay will not come substantially before events occur in their broadcast stream performance. For example, this mitigates or prevents the scenario when some speakers 106A-M are commenting on a goal before other speakers 106A-M can see the goal has occurred in their performance of the broadcast stream.

Similarly, in some embodiments, each speaker 106A-M can intentionally provide a voice input corresponding to some aspect in the broadcast stream to support the determination of latency and corresponding synchronization described herein. For example, each speaker 106A-M can provide verbal input corresponding to a displayed clock time in the broadcast stream by uttering the clock time as they read it off of a display.

Alternatively, in some embodiments, the broadcast stream of a live event is marked with time stamps for comparison with corresponding voice inputs from speakers to determine each speaker's 106A-M individual absolute time delays. The absolute time delays are compared against each other to determine the corresponding relative delays to each other in performance of the broadcast stream. The relative delays are used to adjust delays for synchronization as described herein.

In some embodiments, the server 112 may analyze the broadcast stream to determine a variance score of an audio or video of the broadcast stream within a time period. The variance score may be based on changes detected in audio and/or video frames. Utterance of specific word or phrase, a sudden increase in volume in the audio (e.g. due to fans cheering), or a shift in focus of the video frame, may increase the variance beyond a threshold. In some embodiments, the server 112 may determine an event indication score and an event type associated with the specific point in the broadcast stream of the live event based on the variance score, and at least one of the audio or the video. The variance score may be determined based on a change in audio and/or video across frames within a given time period. In some embodiments, the variance score corresponds to a bit error rate. A sudden change in audio and/or video quality, as reflected in a change in the variance score that exceeds a predetermined quality threshold indicates an event has occurred and the event indication score is incremented. The event indication score may also be determined based on listener responses (e.g. both voice and non-voice, such as likes, ratings, emoticons, etc.).

In some embodiments, the server 112 includes a database of sound effect templates that may be indexed with reference to event types. The event types may be specific to the type of live event (e.g. a sports event, a rock concert, a speech, etc.). The event type may be associated with an emotion or a sentiment such as joy, surprise, disappointment, shock, humor, sadness etc. In some embodiments, if a goal is scored in a soccer match, the server 112 may select a sound effect that is associated with the event type (e.g. a goal) from a database of sound effect templates and append the sound effect (e.g. a congratulatory or celebratory sound effect) to the voice output that is associated with the specific point in the broadcast stream of the live event. In some embodiments, a particular word, phrase or sound is associated with a corresponding event type and event indication score. For example, in some embodiments, sound effects are triggered by a pre-defined phrase (e.g., “sound effect 42” or “laugh”).

In some embodiments, the group of listeners 106N-Z is dynamically selected based on about the same common latency characteristics such as having the same or similar (a) type of broadcast medium, (b) location, or (c) time zone for the group of listeners 106N-Z. When the number of the selected subset of voice outputs is high relative to the time available, the server 112 may dynamically adjust upwards a speed of speech of at least one of the selected subset of voice outputs to enable broadcasting more of the selected subset of voice outputs within a given period of time. In some embodiment, the speed of speech of at least one of the selected subset of voice outputs are at 1.5 times the rate of normal human speech, by increasing the number of words per minute, detecting and shortening pauses, etc.

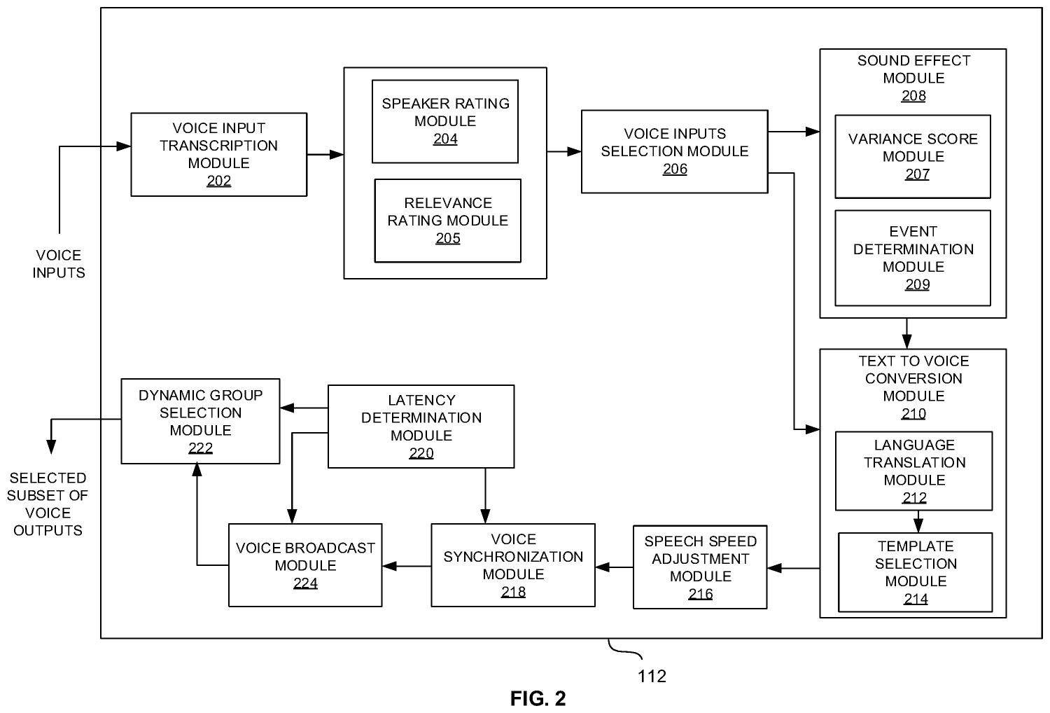

FIG. 2 illustrates a block diagram of the server 112 of FIG. 1 according to some embodiments herein. The server 112 includes a voice input transcription module 202, a speaker rating module 204, a relevance rating module 205, a voice inputs selection module 206, a sound effect module 208, a text to voice conversion module 210, a speech speed adjustment module 216, a voice synchronization module 218, a latency determination module 220, a dynamic group selection module 222 and a voice broadcast module 224. The text to voice conversion module 210 includes a language translation module 212 and a template selection module 214. The voice input transcription module 202 obtains voice inputs associated with a common topic from the speaker devices 108A-M associated with the group of speakers 106A-M. The voice input transcription module 202 automatically transcribes the voice inputs to obtain text segments. The speaker rating module 204 obtains (i) a speaker rating score for at least one speaker in the group of speakers 106A-M. The relevance rating module 205 obtains a relevance rating score with respect to the group of listeners 106N-Z and/or a common topic for at least one of the text segments or the voice inputs.

The voice inputs selection module 206 selects at least a subset of the text segments to produce a selected subset of text segments based on at least one voice input selection criteria selected from (i) the speaker rating score and (ii) the relevance rating score to obtain a selected subset of text segments. The selected subset of text segments is transmitted to both the sound effect module 208 and text to voice conversion module 210.

The sound effect module 208 may include a variance score module 207 that analyzes the broadcast stream to determine a variance score of an audio or video of the broadcast stream within a time period. The sound effect module 208 may also include an event determination module 209 that determines an event indication score and an event type associated with the specific point in the broadcast stream of the live event based on the variance score, and at least one of the audio or the video. The sound effect module 208 selects a sound effect that is associated with the event type from a database of sound effect templates. The database of sound effect templates may include different sound effects (e.g. laughter, loud cheers, celebratory music, yikes voices, disgust voices, etc.), which are associated with different event types (e.g. a goal that is scored, making a point in a debate, a comic fail etc.). The sound effect module 208 may append the sound effect to the voice output that is associated with the specific point in the broadcast stream of the live event. Each sound effect is selected based at least in part on a specific range or type of variance score.

The text to voice conversion module 210 converts the selected subset of text segments into a selected subset of voice outputs. In some embodiments, a voice output of a selected speaker, from the selected subset of voice outputs, is different from a voice input of the selected speaker, from the voice inputs. In some embodiments, the selected subset of voice outputs has less background noise compared to the voice inputs that are obtained from the group of speakers 106A-M.

The language translation module 212 translates the text segments from a first language to a second language that is different than the first language. In some embodiments, the second language is specified in a language preference of the group of listeners 106N-Z. In some embodiments, at least one of the voice inputs are received in the first language and at least one of the selected subset of voice outputs are generated in the second language.

The selected subset of voice outputs may be generated using one or more pre-selected voice templates. The template selection module 214 selects one or more voice templates based on selection of the listeners 106N-Z. In some embodiments, the one or more voice templates are avatar voices. The speech speed adjustment module 216 dynamically adjust a speed of speech of one or more of the selected subset of voice outputs to enable broadcasting more of the selected subset of voice outputs within a given period of time. In some embodiments, the speed of speech of at least one of the selected subset of voice outputs is at 1.5 times the rate of normal human speech, by increasing the number of words per minute, detecting and shortening pauses, etc.

As described herein, the voice synchronization module 218 employs one of multiple methods to determine a latency characteristic. In some preferred embodiments, the voice synchronization module 218 uses timings associated with individual voice inputs from speakers 106A-M reacting to a common event, such as a goal in a sporting competition, are compared against each other to determine their individual relative delays in performance of the broadcast stream. For example, a goal being scored in a sporting event will often prompt a near immediate reaction at various delayed times (latencies) indicative of the delays in broadcast stream playback for each speaker 106A-M. Each speaker's 106A-M verbal input is converted to and compared against the verbal input of other speakers 106A-M to obtain a relative time delay for each of the speakers 106A-M. As the relative time delays are determined, the performance of the verbal output is adjusted (synchronized) so that it is in better sync with that speaker's 106A-M broadcast stream.

Similarly, in some embodiments, the voice synchronization module 218 uses intentionally provided voice input corresponding to some aspect in the broadcast stream to support the determination of latency and corresponding synchronization described herein. For example, each speaker 106A-M can provide verbal input corresponding to a displayed clock time in the broadcast stream by uttering the clock time as they read it off of a display.

Alternatively, in some embodiments, the voice synchronization module 218 uses time stamps marking the broadcast stream of a live event for comparison with corresponding voice inputs from speakers to determine each speaker's 106A-M individual absolute time delays. The absolute time delays are compared against each other to determine the corresponding relative delays to each other in performance of the broadcast stream. The relative delays are used to adjust delays for synchronization as described herein.

In some embodiments, a timing of broadcast of a voice output that is generated based on the at least one of the voice inputs is synchronized with the specific point in the broadcast stream of the live event by individually compensating for the latency in receiving the broadcast stream by the group of listeners 106N-Z to enable a more simultaneous receipt of the voice outputs by the group of listeners 106N-Z. In some embodiments, voice inputs from speakers having a lower latency are delayed to synchronize with voice inputs from speakers having a higher latency. The latency determination module 220 determines one or more latency characteristics selected from (a) a type of broadcast medium, (b) a location, or (c) a time zone of a live event for the group of listeners 106N-Z, and transmits a latency determination to the voice synchronization module 218, the dynamic group selection module 222 and the voice broadcast module 224.

The dynamic group selection module 222 dynamically selects the group of listeners 106N—Z based on group selection criteria selected from at least one of (i) a quantity of voice inputs or (ii) speaker rating scores given by each of the group of listeners 106N-Z to speakers associated with a selected subset of text segments to split the group of listeners 106N-Z into the first group of listeners 114 (e.g. the listener 106N and the listener 106X) and the second group of listeners 116 (e.g. the listener 106Y and the listener 106Z). In some embodiments, the listeners may be dynamically split into the first group of listeners 114 and the second group of listeners 116 based on the speaker rating scores of the speakers and the relevance rating scores of the speakers for different listeners. For example, the common topic may be one with opposing sets of views with reference to different sets of opinions, political views, opposing sides playing sports such as soccer, tennis etc., fans of one band versus fans of another band, etc. Depending on the preferences of the listeners, relevance rating scores, and their tolerance levels to different views, they may be split into groups.

In some embodiments, a first selected subset of voice outputs is serially broadcasted to the first group of listener devices (e.g. the listener device 108N and the listener device 108X) associated with the first group of listeners 114. In some embodiments, a second selected subset of voice outputs is serially broadcasted to the second group of listener devices (e.g. the listener device 108Y and the listener device 108Z) associated with the second group of listeners 116. The first selected subset of voice outputs is determined based on (i) a speaker rating score, and (ii) a relevance rating score of a first set of speakers with respect to a common topic and/or the first group of listeners 114. The second selected subset of voice outputs is determined based on (i) a speaker rating score, and (ii) a relevance rating score of a second set of speakers with respect to a common topic and/or the second group of listeners 116. The dynamic group selection module 222 may dynamically select the group of listeners 106N—Z based on the one or more latency characteristics that are common to the group of listeners 106N-Z. The voice broadcast module 224 serially broadcasts the subset of voice outputs to the listener devices 108N-Z of the group of listeners 106N-Z.

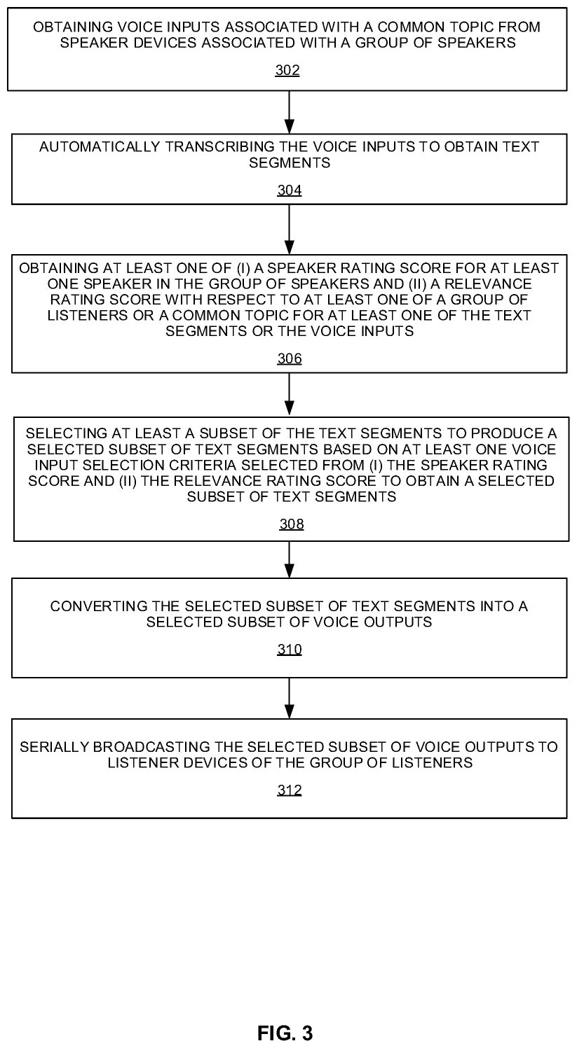

FIG. 3 is a flow diagram that illustrates a method of broadcasting from the group of speakers 106A-M having the speaker devices 108A-M to the group of listeners 106N-Z having the listener devices 108N-Z according to some embodiments herein. At step 302, voice inputs associated with a common topic are obtained from the speaker devices 108A-M associated with the group of speakers 106A-M. At step 304, the voice inputs are automatically transcribed to obtain text segments. At step 306, at least one of (a) a speaker rating score for at least one speaker in the group of speakers 106A-M and (ii) a relevance rating score with respect to at least one of the group of listeners 106N-Z or a common topic for at least one of the text segments or the voice inputs are obtained.

At step 308, at least a subset of the text segments is selected to produce a selected subset of text segments based on at least one voice input selection criteria selected from (i) the speaker rating score and (ii) the relevance rating score to obtain a selected subset of text segments. At step 310, the selected subset of text segments is converted into a selected subset of voice outputs. A voice output of a selected speaker, from the selected subset of voice outputs, is different from a voice input of the selected speaker, from the voice inputs. At step 312, the selected subset of voice outputs is serially broadcasted to the listener devices 108N-Z of the group of listeners 106N-Z.

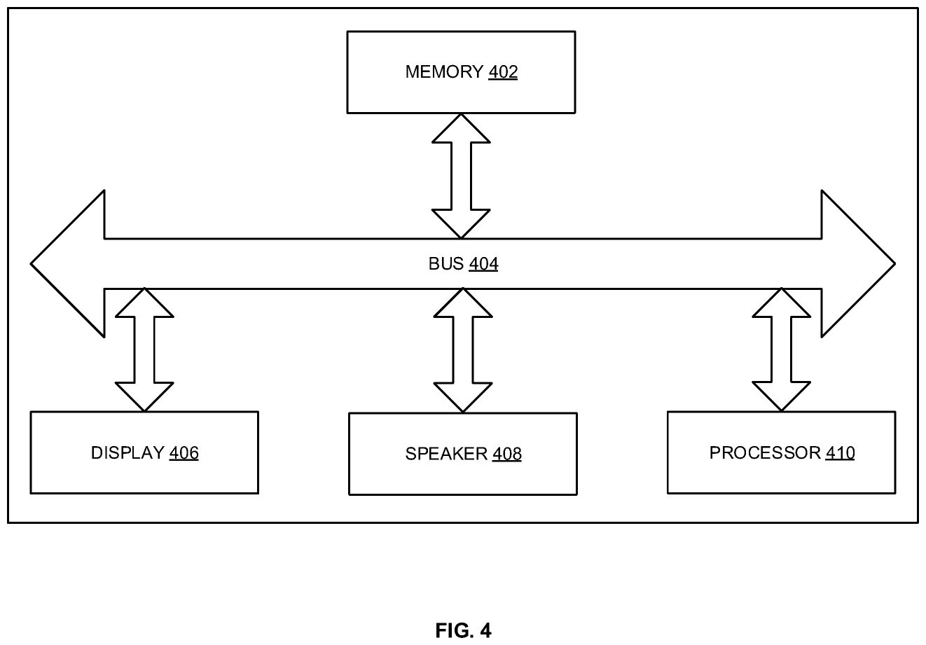

FIG. 4 illustrates a block diagram of a speaker device and a listener device of FIG. 1 according to some embodiments herein. The device (e.g. the speaker device or the listener device) may have a memory 402 having a set of computer instructions, a bus 404, a display 406, a speaker 408, and a processor 410 capable of processing a set of instructions to perform any one or more of the methodologies herein, according to some embodiments herein. The device includes a microphone to capture voice inputs from the speakers. The processor 410 may also carry out the methods described herein and in accordance with the embodiments herein.

The techniques provided by the embodiments herein may be implemented on an integrated circuit chip. The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

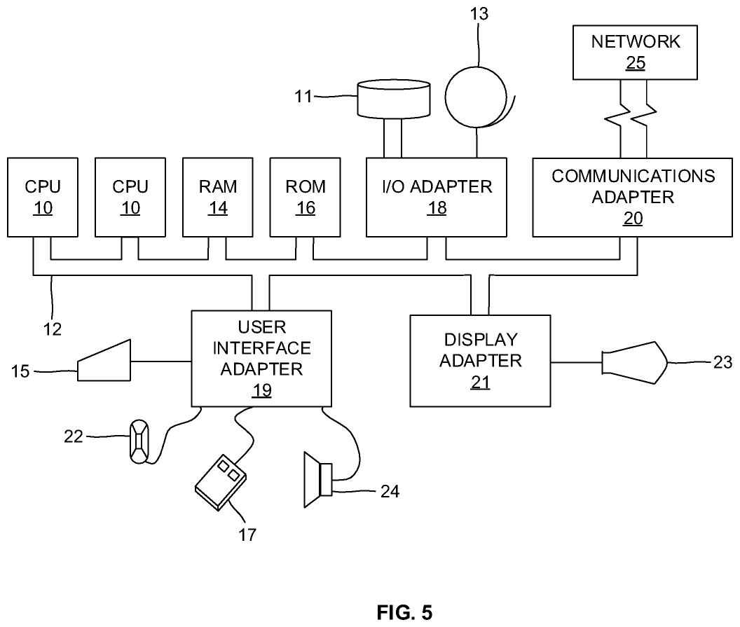

FIG. 5 is a block diagram of the server 112 of FIG. 1 used in accordance with some embodiments herein. The server 112 comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor implemented method for broadcasting from a group of speakers having a plurality of speaker devices to a group of listeners having a plurality of listener devices, comprising:
obtaining a plurality of voice inputs associated with a common topic from the plurality of speaker devices associated with the group of speakers;
automatically transcribing the plurality of voice inputs to obtain a plurality of text segments;
obtaining at least one of (i) a speaker rating score for at least one speaker in the group of speakers and (ii) a relevance rating score with respect to at least one of the group of listeners or a common topic for at least one of the plurality of text segments or the plurality of voice inputs;
selecting at least a subset of the plurality of text segments to produce a selected subset of text segments based on at least one voice input selection criteria selected from (i) the speaker rating score and (ii) the relevance rating score to obtain a selected subset of text segments;
converting the selected subset of text segments into a selected subset of voice outputs, wherein a voice output of a selected speaker, from the selected subset of voice outputs, is different from a voice input of the selected speaker, from the plurality of voice inputs; and
serially broadcasting the selected subset of voice outputs to the plurality of listener devices of the group of listeners.

2. The processor implemented method of claim 1, further comprising:
dynamically selecting the group of listeners based on group selection criteria selected from at least one of (i) a quantity of voice inputs or (ii) speaker rating scores given by each of the group of listeners to speakers associated with a selected subset of text segments to split the group of listeners into a first group of listeners and a second group of listeners, wherein a first selected subset of voice outputs is serially broadcasted to a first group of listener devices associated with the first group of listeners, wherein a second selected subset of voice outputs is serially broadcasted to a second group of listener devices associated with the second group of listeners.

3. The processor implemented method of claim 1, wherein the at least one speaker is a member of the first group of listeners and the second group of listeners.

4. The processor implemented method of claim 2, wherein the first selected subset of voice outputs is determined based on (i) a speaker rating score, and (ii) a relevance rating score of a first set of speakers with respect to at least one of the first group of listeners or a common topic, wherein the second selected subset of voice outputs is determined based on (i) a speaker rating score, and (ii) a relevance rating score of a second set of speakers with respect to at least one of the second group of listeners or a common topic.

5. The processor implemented method of claim 1, further comprising:
translating the text segments from a first language to a second language, wherein the second language is different than the first language and the second language is specified in a language preference of the group of listeners, wherein at least one of the voice inputs are received in the first language and at least one of the selected subset of voice outputs are generated in the second language.

6. The processor implemented method of claim 1, further comprising:
obtaining an input time stamp associated with at least one of the plurality of voice inputs to determine a latency characteristic by comparing the input time stamp against a reference time clock, wherein the common topic is a broadcast stream of a live event; and
associating the input time stamp associated with the at least one of the plurality of voice inputs with a specific point identified by the reference time clock in the broadcast stream of the live event, wherein a timing of broadcast of a voice output that is generated based on the at least one of the voice inputs is synchronized with the specific point in the broadcast stream of the live event by individually compensating for the latency in receiving the broadcast stream by the group of listeners, wherein voice inputs from speakers having a lower latency are delayed to synchronize with voice inputs from speakers having a higher latency.

7. The processor implemented method of claim 6, further comprising
analyzing the broadcast stream to determine a variance score of an audio or video of the broadcast stream within a time period;
determining an event indication score and an event type associated with the specific point in the broadcast stream of the live event based on the variance score, and at least one of the audio or the video;
selecting a sound effect that is associated with the event type from a database of sound effect templates; and
appending the sound effect to the voice output that is associated with the specific point in the broadcast stream of the live event.

8. The processor implemented method of claim 1, further comprising:
dynamically adjusting a speed of speech of one or more of the selected subset of voice outputs to enable broadcasting more of the selected subset of voice outputs within a given period of time.

9. The processor implemented method of claim 1, further comprising:
determining one or more latency characteristics selected from (a) a type of broadcast medium, (b) a location, or (c) a time zone of a live event for the group of listeners.

10. The processor implemented method of claim 9, further comprising:
dynamically selecting the group of listeners based on the one or more latency characteristics that are common to the group of listeners.

11. A system for broadcasting from a group of speakers having a plurality of speaker devices to a group of listeners having a plurality of listener devices, the system comprising:
a memory that stores a set of instructions; and
a processor that executes the set of instructions and is configured to
obtain a plurality of voice inputs associated with a common topic from the plurality of speaker devices associated with the group of speakers;
automatically transcribe the plurality of voice inputs to obtain a plurality of text segments;
obtain at least one of (i) a speaker rating score for at least one speaker in the group of speakers and (ii) a relevance rating score with respect to at least one of the group of listeners or a common topic for at least one of the plurality of text segments or the plurality of voice inputs;
select at least a subset of the plurality of text segments to produce a selected subset of text segments based on at least one voice input selection criteria selected from (i) the speaker rating score and (ii) the relevance rating score to obtain a selected subset of text segments;
convert the selected subset of text segments into a selected subset of voice outputs, wherein a voice output of a selected speaker, from the selected subset of voice outputs, is different from a voice input of the selected speaker, from the plurality of voice inputs; and
serially broadcast the selected subset of voice outputs to the plurality of listener devices of the group of listeners.

12. The system of claim 11, wherein the processor is further configured to dynamically select the group of listeners based on group selection criteria selected from at least one of (i) a quantity of voice inputs or (ii) speaker rating scores given by each of the group of listeners to speakers associated with a selected subset of text segments to split the group of listeners into a first group of listeners and a second group of listeners, wherein a first selected subset of voice outputs is serially broadcasted to a first group of listener devices associated with the first group of listeners, wherein a second selected subset of voice outputs is serially broadcasted to a second group of listener devices associated with the second group of listeners.

13. The system of claim 12, wherein the first selected subset of voice outputs is determined based on (i) a speaker rating score, and (ii) a relevance rating score of a first set of speakers with respect to at least one of the first group of listeners or a common topic, wherein the second selected subset of voice outputs is determined based on (i) a speaker rating score, and (ii) a relevance rating score of a second set of speakers with respect to at least one of the second group of listeners or a common topic.

14. The system of claim 11, wherein the processor is further configured to translate the text segments from a first language to a second language, wherein the second language is different than the first language and the second language is specified in a language preference of the group of listeners, wherein at least one of the voice inputs are received in the first language and at least one of the selected subset of voice outputs are generated in the second language.

15. The system of claim 11, wherein the processor is further configured to
obtain an input time stamp associated with at least one of the voice inputs to determine a latency characteristic by comparing the input time stamp against a reference time clock, wherein the common topic is a broadcast stream of a live event; and
associate the input time stamp associated with the at least one of the plurality of voice inputs with a specific point identified by the reference time clock in the broadcast stream of the live event, wherein a timing of broadcast of a voice output that is generated based on the at least one of the voice inputs is synchronized with the specific point in the broadcast stream of the live event by individually compensating for the latency in receiving the broadcast stream by the group of listeners, wherein voice inputs from speakers having a lower latency are delayed to synchronize with voice inputs from speakers having a higher latency.

16. The system of claim 15, wherein the processor is further configured to
analyze the broadcast stream to determine a variance score of an audio or video of the broadcast stream within a time period;
determine an event indication score and an event type associated with the specific point in the broadcast stream of the live event based on the variance score, and at least one of the audio or the video;
select a sound effect that is associated with the event type from a database of sound effect templates; and
append the sound effect to the voice output that is associated with the specific point in the broadcast stream of the live event.

17. The system of claim 11, wherein the processor is further configured to dynamically adjust a speed of speech of one or more of the selected subset of voice outputs to enable broadcasting more of the selected subset of voice outputs within a given period of time.

18. The system of claim 11, wherein the processor is further configured to determine one or more latency characteristics selected from (a) a type of broadcast medium, (b) a location, or (c) a time zone of a live event for the group of listeners.

19. The system of claim 18, wherein the processor is further configured to dynamically select the selected group of listeners based on the one or more latency characteristics that are common to the group of listeners.

20. One or more non-transitory computer readable storage mediums storing one or more sequences of instructions, which when executed by one or more processors, causes a processor implemented method for broadcasting from a group of speakers having a plurality of speaker devices to a group of listeners having a plurality of listener devices by performing the steps of:
obtaining a plurality of voice inputs associated with a common topic from the plurality of speaker devices associated with the group of speakers;
automatically transcribing the plurality of voice inputs to obtain a plurality of text segments;
obtaining at least one of (i) a speaker rating score for at least one speaker in the group of speakers and (ii) a relevance rating score with respect to at least one of the group of listeners or a common topic for at least one of the plurality of text segments or the plurality of voice inputs;
selecting at least a subset of the plurality of text segments to produce a selected subset of text segments based on at least one voice input selection criteria selected from (i) the speaker rating score and (ii) the relevance rating score to obtain a selected subset of text segments;
converting the selected subset of text segments into a selected subset of voice outputs, wherein a voice output of a selected speaker, from the selected subset of voice outputs, is different from a voice input of the selected speaker, from the plurality of voice inputs; and
serially broadcasting the selected subset of voice outputs to the plurality of listener devices of the group of listeners.

21. The one or more non-transitory computer readable storage mediums storing the one or more sequences of instructions of claim 20, which when executed by one or more processors, further causes dynamically selecting the group of listeners based on group selection criteria selected from at least one of (i) a quantity of voice inputs or (ii) speaker rating scores given by each of the group of listeners to speakers associated with a selected subset of text segments to split the group of listeners into a first group of listeners and a second group of listeners, wherein a first selected subset of voice outputs is serially broadcasted to a first group of listener devices associated with the first group of listeners, wherein a second selected subset of voice outputs is serially broadcasted to a second group of listener devices associated with the second group of listeners.

22. The one or more non-transitory computer readable storage mediums storing the one or more sequences of instructions of claim 21, wherein the first selected subset of voice outputs is determined based on (i) a speaker rating score, and (ii) a relevance rating score of a first set of speakers with respect to at least one of the first group of listeners or a common topic, wherein the second selected subset of voice outputs is determined based on (i) a speaker rating score, and (ii) a relevance rating score of a second set of speakers with respect to at least one of the second group of listeners or a common topic.

23. The one or more non-transitory computer readable storage mediums storing the one or more sequences of instructions of claim 20, which when executed by one or more processors, further causes translating the text segments from a first language to a second language, wherein the second language is different than the first language and the second language is specified in a language preference of the group of listeners, wherein at least one of the voice inputs are received in the first language and at least one of the selected subset of voice outputs are generated in the second language.

24. The one or more non-transitory computer readable storage mediums storing the one or more sequences of instructions of claim 20, which when executed by one or more processors, further causes
obtaining an input time stamp associated with at least one of the plurality of voice inputs to determine a latency characteristic by comparing the input time stamp against a reference time clock, wherein the common topic is a broadcast stream of a live event; and
associating the input time stamp associated with the at least one of the plurality of voice inputs with a specific point identified by the reference time clock in the broadcast stream of the live event, wherein a timing of broadcast of a voice output that is generated based on the at least one of the voice inputs is synchronized with the specific point in the broadcast stream of the live event by individually compensating for the latency in receiving the broadcast stream by the group of listeners, wherein voice inputs from speakers having a lower latency are delayed to synchronize with voice inputs from speakers having a higher latency.
